(19) United States
(12) Patent Application Publication
(10) Pub. No.: US 2008/0250085 A1
(43) Pub. Date: Oct. 9, 2008

(54) Backup system having preinstalled backup data

(75) Inventors: James Christopher Gray, Belllevue, WA (US); Cesare John Saretto, Seattle, WA (US); Charles Kindel, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/784,862

(22) Filed: Apr. 9, 2007

(51) Int. Cl. G06F 17/30

(52) U.S. Cl. 707/204; 707/E17.005

(57) ABSTRACT

A backup system has a set of temporary backup data stored on a data storage system. When performing a backup operation for a device over a network, a block of data on the device may be compared to blocks of the temporary backup data. If the block of data already exists on the backup system in the temporary backup data, the block of data is not transferred over the network. Comparisons between blocks of data may be performed by calculating and comparing a hash value for the blocks.

### BACKGROUND

Backup systems may used to store archive copies of computer applications and data from a computer system to a storage device. In some embodiments, backup systems may be used to store backup data from multiple devices that may be connected to the backup system over a network.

Backup systems may be capable of restoring backup data. In some cases, a backup system may be able to restore a single file to a previously stored state. In other cases, a backup system may be capable of restoring an entire data storage system of a device, such as a case whereby a disk storage system may be rebuilt or restored from backup data.

### SUMMARY

A backup system has a set of temporary backup data stored on a data storage system. When performing a backup operation for a device over a network, a block of data on the device may be compared to blocks of the temporary backup data. If the block of data already exists on the backup system in the temporary backup data, the block of data is not transferred over the network. Comparisons between blocks of data may be performed by calculating and comparing a hash value for the blocks.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram of an embodiment showing a system with a backup server.

FIG. 2 is a flowchart illustration of an embodiment showing a method for creating and using a backup system.

FIG. 3 is a diagram of an embodiment showing a database structure for a backup database.

FIG. 4 is a flowchart illustration of an embodiment showing a method for backing up using hash values.

### DETAILED DESCRIPTION

A backup system may have pre-installed backup data. During a backup operation, especially an initial backup operation, comparisons are made between the pre-installed backup data and data from a device to be backed up. If the data to be backed up are already present on the backup system, the data are not copied onto the backup system, but a pointer to the existing data is used to designate the block of data.

With many backup systems, the initial backup of a data storage system on a device may be a very lengthy process, as each file or block of data may be transferred from the device to the backup system. By having some of the data pre-installed, the data transfer time may be significantly reduced.

The pre-installed data may be any portion of a set of backup data. In some instances, the pre-installed data may be a subset of data that would be backed up. For example, an application executable file having 100 blocks of data may be pre-installed on a backup system with one missing block of data. Because the block of data is missing, the application executable file in the pre-installed data may not be usable. During a backup operation, the missing block of data may be transferred to the backup system but the remaining 99 blocks may not be transferred.

Each block of data on a remote device may be compared to a pre-installed block of data by computing and comparing a hash value for the blocks of data. If the hash values are equal, the blocks of data may be assumed to be equal.

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

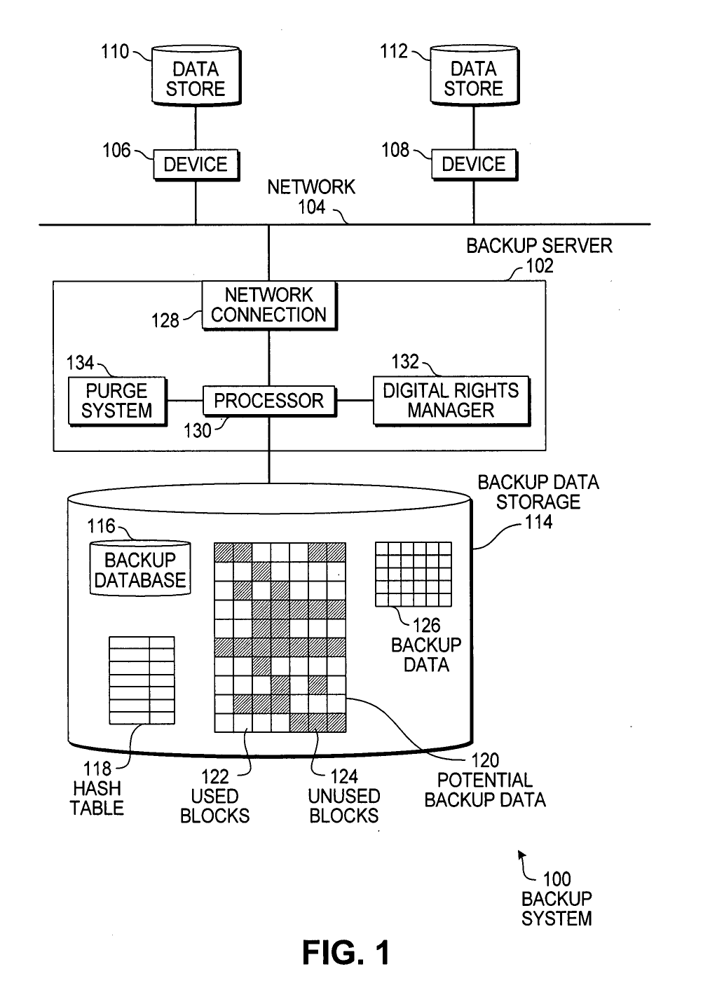

FIG. 1 is a diagram of an embodiment 100 showing a backup system. The backup system uses a backup server 102 attached to a network 104 and may provide backup services to devices 106 and 108 attached to the network to backup the data stores 110 and 112.

The embodiment 100 is a typical embodiment of a computer network where a centralized backup server 102 may provide a secondary or archive backup of the various data stores attached to devices such as personal computers in a local area network. Other embodiments may use a central backup server that stores the contents of devices such as hand held devices, mobile telephony devices, personal digital assistants, distributed industrial controllers, or any other device.

The backup server 102 may provide data backup services for various devices. The data backup services may also include data recovery services, such as restoring a single file from a data archive as well as rebuilding an entire file structure or restoring a data storage device to a previous state. In some embodiments, a backup server 102 may be adapted to rebuild or restore a computer system to a previously stored state.

The backup server 102 uses a backup data storage 114 that may be, for example, one or more hard disk storage devices or other memory devices. For example, a multiple hard disk storage embodiment may have multiple disks arranged in a RAID format. In some instances, some or all of the backup data storage 114 may be a read/write memory device while in other instances, some or all of the backup data storage 114 may be a write once, read only device such as an optical storage medium or other similar medium.

The backup data storage 114 may include a backup database 116, a hash table 118, and potential backup data 120. The potential backup data 120 may include used blocks 122 and unused blocks 124. The backup data storage 114 may also include backup data 126.

The backup server 102 may comprise a network connection 128 and a processor 130 that may execute a backup application as well as other tasks. A digital rights management system 132 and a purge system 134 may also be components of the backup server 102.

The embodiment 100 uses a block of potential backup data 120 that may be installed on the backup data storage 114 at a time prior to performing a backup operation on one of the devices 106 or 108. The block of potential backup data 120 may be referenced during a backup operation and if the block of data to be backed up already exists within the potential backup data 120, the block can merely be referenced in the backup database 116.

When the block of potential backup data 120 is referenced in such a manner, the block would not be copied from the remote device to the backup data store 114. Because the block is not copied over the network 104, the backup process may be much faster than if the block of data were transmitted over the network 104. In some embodiments, such a system may reduce backup times from several hours to a handful of minutes.

Backup servers 102 are typically devices that have a large amount of data storage and may be used to backup multiple devices. In a typical embodiment, the backup server 102 may perform a backup of a device on a periodic basis, such as nightly or weekly backups. Over time, the backup data store 114 may grow as different revisions of backups are kept.

The backup server 102 may come preloaded with a set of potential backup data 120. The potential backup data 120 may include many different applications, operating systems, data files, or other data that may possibly be contained on the various remote devices 106 and 108. Because the backup data storage device 114 may be very large, the potential backup data 120 may also be correspondingly large and may include a wide variety of applications, operating systems, and other data, many of which may not be found on the various remote devices.

As backup operations are performed, portions of the potential backup data 120 may become the used blocks 122 while the remaining portions become the unused blocks 124. The backup data 126 may include blocks of data that were not found in the potential backup data 120 and were copied into the backup data store 114 from a remote device. As the backup data 126 increases in size during successive backup operations, the unused blocks 124 of the potential backup data 120 may be deleted to make room. Such a purge operation may be performed by the purge system 134 within the backup server 102.

The potential backup data 120 is backup data that may or may not be used to perform a backup operation. It may be placed on the backup server 102 to facilitate and greatly speed up initial and, to a lesser degree, subsequent backup operations.

The potential backup data 120 may include a large amount of data such as applications, operating systems, and other data. In many cases, the potential backup data 120 may include data that are copyrighted and/or licensed products. In some embodiments, the potential backup data 120 may include disabled versions of the licensed products so that the potential backup data 120 may not misappropriated and used.

The potential backup data 120 may be disabled in several different manners. In some embodiments, the potential backup data 120 may include disabled versions of an application. For example, an application that uses a keyword or other authorization component may be in the potential backup data 120 without the authorization component. In another example, a file having multiple blocks of data may be stored in the potential backup data 120 with one or more of the blocks of data omitted.

In some embodiments, a digital rights manager 132 may be used to secure the potential backup data 120 from surreptitious or unauthorized use. The digital rights manager 132 may allow the blocks of data within the potential backup data 120 to be used for the purposes of expediting a backup operation but may not allow other uses of the data. The mechanisms for controlling the use of the potential backup data 120 with a digital rights manager 132 may vary widely and different authentication and control technologies may be used.

The backup server 102 may be a standalone device connected to the network 104 that performs backup services for one or more other devices. In some embodiments, the backup server 102 may be an application that operates on a computer or server device.

The backup data storage 114 is illustrated as being attached to the backup server 102. In other embodiments, the backup data storage 114 may be connected to the backup server 102 through the network 104. In some such embodiments, the backup data storage 114 may be located remotely, and may be connected to the backup server 102 through a wide area network connection such as the Internet. In other embodiments, the backup server 102 and backup data storage 114 may be connected to the various devices through a wide area network connection, including the Internet.

In some embodiments, the network 104 may be a local area network with a hardwired connection between the various devices. In other embodiments, the network 104 may comprise a wireless connection, wide area network connections, the Internet, or any other medium through which a device may communicate.

Various mechanisms may be used by the backup server 102 to compare data on a remote device with data in the potential backup data 120 to determine if the data is to be copied across the network 104.

One mechanism for generating a backup may include traversing a directory structure and performing a backup that consists of recreating the directory structure on the backup media and backing up each file contained in each directory. In a typical embodiment of such a system, a full backup may include generating a copy of each file on the target backup medium and subsequent backup operations may include generating subsequent incremental backups that include the data that have changed since a previous backup.

Another mechanism for generating a backup may be to traverse a data storage medium block by block without regard to a directory or file structure. Other mechanisms may also be used.

In order to use the potential backup data 120, each block or group of data to be backed up is compared to blocks of data within the potential backup data 120 to determine a match. If the data match, a pointer may be matched data within the potential backup data 120 may be stored in the backup database 116. If the data does not match, the data may be copied into the backup data 126.

The backup database 116 may contain pointers to various blocks of data in the backup data 126 and the used blocks 122 of the potential backup data 120. The backup database 116 may be used to restore data by placing the blocks of backup data in their original sequence or place.

In some embodiments, a block of backup data may be a single size block of data that is used throughout the embodiment. Such an arrangement may be useful in a backup system that uses a block by block backup mechanism, and the block of data may correspond with a physical block of data used by a data storage system, for example. In other embodiments, a block of data may vary in size from one block to the next. Such an arrangement may be useful in a backup system that used a file by file backup mechanism. Various embodiments may use different definitions of a block of data.

In order to determine if a block of data to be copied to the backup data storage 114, a hash value may be calculated for the block and compared to hash values in the hash table 118. The hash table 118 may contain hash values for the blocks of potential backup data 120 as well as the backup data 126. If the calculated hash value is found in the hash table 118, the block to be copied may be considered identical to one of the blocks already contained in the backup data storage 114 and a pointer to the block may be stored in the backup database 116.

Various mechanisms may be used to calculate a hash value for a block of data. A hash value is a calculated value from a group of data that may be considered unique for that particular block of data. Some hash algorithms have been created that have an extremely high degree of confidence that two blocks with identical hash values also have identical bit by bit data. In the absence of using hash values to compare blocks of data, bit by bit comparisons may be made between the blocks. In some instances, a hash value comparison may be used in addition to a bit by bit comparison of the blocks of data.

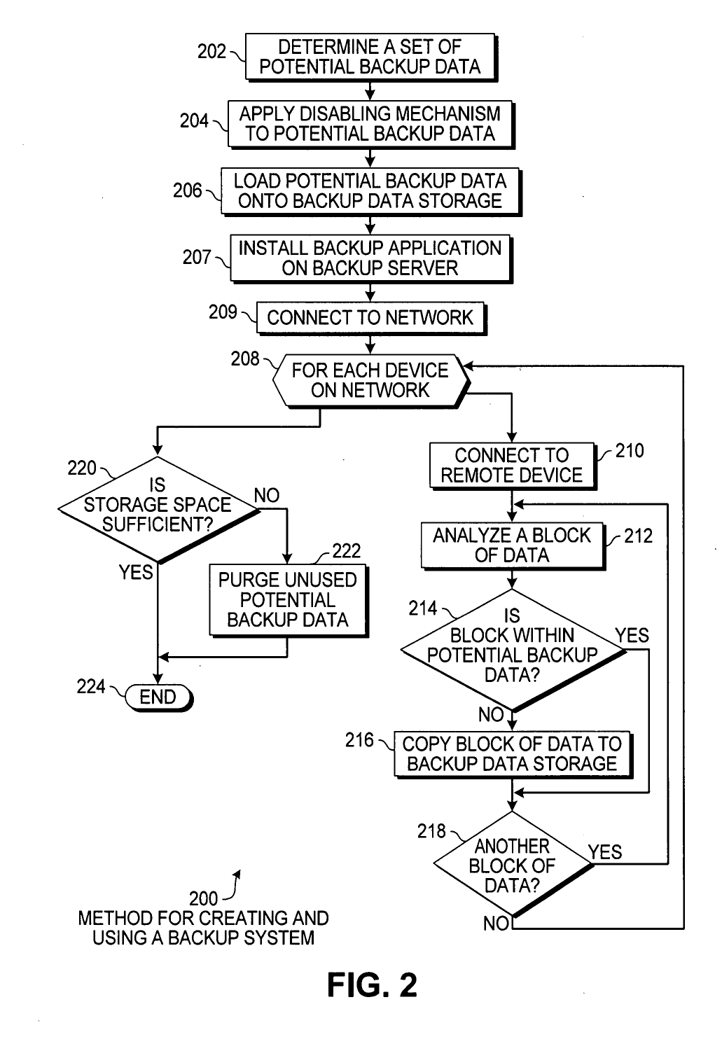

FIG. 2 is a flowchart illustration of an embodiment 200 showing a method for creating and using a backup system. Embodiment 200 illustrates one method by which a backup system may be created and a general method by which backups may be performed and a purge may be done for unused portions of potential backup data.

A set of potential backup data is determined in block 202. In some instances, a set of potential backup data may include many different versions of operating systems, applications, and raw data that might be used. In other instances, a user may select a list or group of applications, operating systems, and raw data that may be included in a specific version of a backup system.

For example, a user may order a backup system for use in backing up several devices that use a specific set of applications and operate with a specific version of an operating system. In such an example, the potential backup data set may include the specified applications and operating system. In some embodiments, the potential backup data may be limited to those selections. In other embodiments, the potential backup data may include many more applications or operating system in addition to those specified.

A disabling mechanism may be applied to the potential backup data in block 204. In some embodiments, a disabling mechanism may be to remove specific blocks of data from the set of potential backup data. In such an embodiment, a backup scenario may include copying the missing blocks of data from the remote device. By combining the missing block of data with the blocks of data in the set of potential backup data, a working version of an application, operating system, or other data may be created. However, the potential backup data may not include enough data so that a working version of the application may be created.

Another disabling mechanism may be to use a digital rights management system to permit or deny certain data to be used. When a complete and authenticated version of a protected group of data is detected on a remote device, a digital rights management system may permit the same group of data within the potential backup data to be used by the remote device for backup purposes.

The potential backup data may be loaded onto the backup data storage in block 206. In some embodiments, a manufacturer of backup systems may be able to load large amounts of potential backup data onto a backup data storage in an easy and efficient manner during manufacturing. In such an embodiment, the portion of the potential backup data that is actually used in a backup operation may be very small in comparison to the size of the potential backup data. For example, a set of potential backup data may include an entire library of applications provided by multiple software vendors and a device that is backed up may only have one or two of the applications installed.

In other embodiments, a more focused set of potential backup data may be loaded on the backup storage media, and the set tailored to a specific implementation. By loading backup data onto the backup data storage in block 206, the backup system may be configured to perform a backup on a specific device or group of devices on a specific network environment. In many embodiments, potential backup data may be loaded onto a backup server when the backup server is manufactured and sent to an end user. For example, such backup data may include data files or portions of data files for movies, audio tracks, or other data for which the end user may have existing licenses, as well as software applications or other licensed content.

In other embodiments, potential backup data may be loaded onto an existing and deployed backup server in preparation to backup a specific device or when a new application or dataset is installed on the remote device. Such a use may enable a very rapid backup of a remote device. In such an embodiment, potential backup data may be loaded onto a backup system during a period of low network traffic or while the remote device is operational. Rather than spending a long period of time performing an backup of the remote device with a newly installed application, a set of potential backup data may be preloaded onto the backup server so that the backup operation of the remote device is very rapid. Such a use may cause the remote device to use much less network bandwidth and much less time to perform the backup operation.

In some embodiments, potential backup data may be added to an existing backup server when a new application or group of data may be installed onto a remote device for which a backup operation has already been performed.

Potential backup data may be transferred to the backup server through a secondary data connection, such as through a DVD reader attached to the backup server, or through a secondary network connection rather than through a network connection by which a remote device is connected. Other embodiments may transfer additional potential backup data over a network connection during a period of inactivity of the network.

For an initial configuration of a backup server, a backup application may be installed on a backup server in block 207. In some embodiments, a backup application may comprise executable and data files that perform various tasks, display user interfaces, and other functions associated with performing a backup process.

Many embodiments may have a backup application that is executed on a backup server. In such an embodiment, a backup server may connect to a data store on a remote device and pull data to be backed up. In other embodiments, a backup application may operate on a remote device and operate by pushing data to a backup system.

The backup server is attached to a network in block 209. The network may be any type of communications medium through which two devices may communicate, including wired, wireless, and any combination of communications media. In some embodiments, routers, servers, or other devices may be used to bridge between different communications media or communications protocol to connect the various devices.

In some embodiments, a backup operation may be performed on a single device. For example, a backup server application may be installed on a standalone device and operated with a detachable or fixed set of backup media attached to the device. As an example, a backup storage device in the form of a detachable hard disk system may have pre-installed potential backup data and a backup application executed by the device to backup the device to the detachable hard disk system. The present embodiment illustrates a backup system operated over a network to backup one or more devices connected to the network.

For each device on the network in block 208, a connection is made to the remote device in block 210. A block of data to be backed up is analyzed in block 212 and if the block of data is not within the potential backup data in block 214, the block of data is copied from the remote device to the backup data store in block 216. If the block of data is already within the potential block of data in block 214, the block of data is skipped. If more blocks of data exist in block 218, the process is repeated at block 212. When all the blocks of data have been processed in block 218, the process begins with another network device in block 208.

The process of backing up an individual device comprises analyzing a block of data to determine if the block of data is already on the backup server. If the block already exists, the block is skipped. By skipping blocks of data, the time for a backup process may be significantly reduced by orders of magnitude. Much of the time used by a backup process is the transferring of data to the backup storage. Because much of the data may exist on the backup storage in the form of potential backup data, the time may be greatly reduced.

If the storage space on the backup system is running low in block 220, unused blocks of potential backup data may be purged in block 222 and the process ends in block 224. If the storage space is sufficient in block 220, the process ends in block 224.

In some embodiments, the potential backup data may be grouped into a set of used blocks and unused blocks of data. After an initial backup of a remote device or group of devices, the set of unused blocks of data may occupy a large amount of storage space on the backup system. Since these blocks of data have not been allocated or used by previous backup operations, all or a portion of the set of unused blocks of data may be removed from the backup storage media to make room for other backup data.

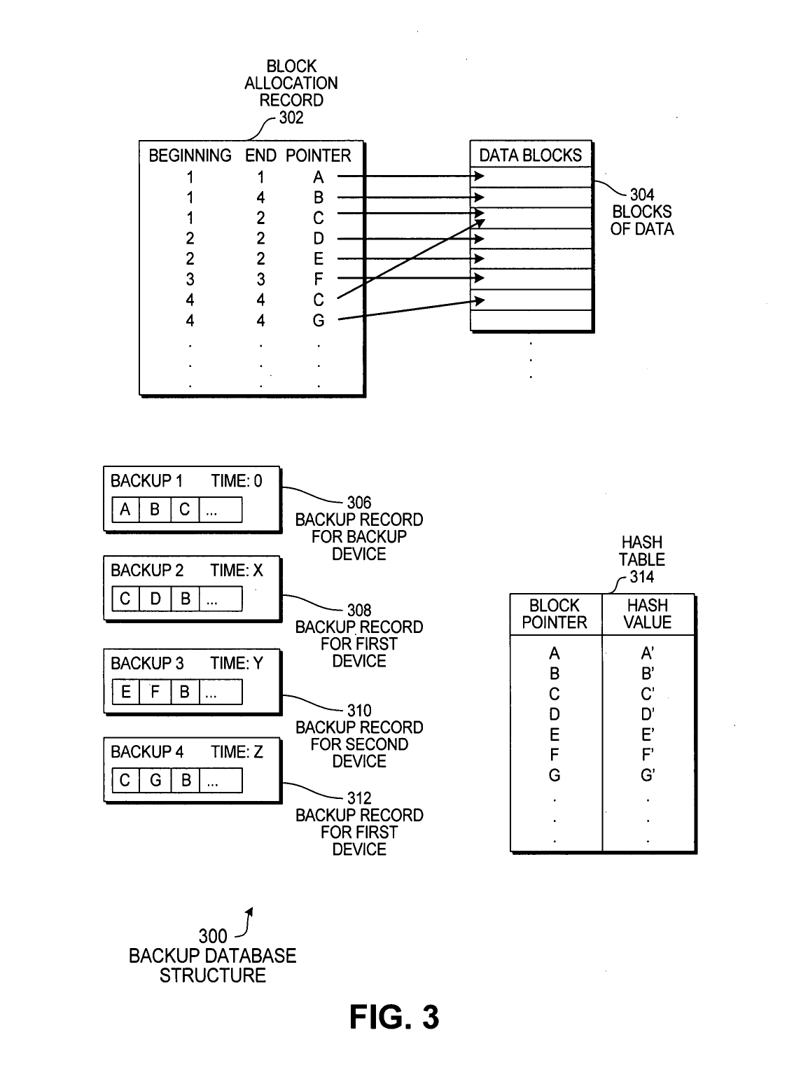

FIG. 3 is a diagram of an embodiment 300 showing a backup database structure. The structure illustrated here is merely one example of how a backup system may use a database to reuse blocks of data, including potential backup data. The structure may enable multiple uses of a block of data across different backup operations executed for different devices. When a block of data may be used multiple times, the size of the backup storage system may be reduced as well as the time required to copy blocks of data to the backup storage system.

Embodiment 300 is only one example of a data structure that may be used to store blocks of data. Other embodiments may use different records, relations, and database concepts to define the relationship between blocks of data and various backup operations.

The data structure of embodiment 300 may contain a block allocation record 302 that defines which backup record uses specific blocks of data. The block allocation record 302 may contain, among other things, pointers to actual blocks of backup data 304 that may be large blocks of data.

In some instances, the blocks of data 304 may be blocks of data that correspond with a block of data used on a hard disk or other storage medium. In other cases, a block of data 304 may be a file or a random length group of data. In some cases, multiple blocks of data may make up a single file in a file system, while in other cases, multiple files may make up a single block of data.

The embodiment 300 illustrates a database that has four different backup records 306, 308, 310, and 312. Each of the backup records contains the sequence of data blocks 304 that make up the original version of the data on the specific device. For example, backup record 306 was a backup made for the backup device and contains blocks A, B, C. Backup record 308 was made for a first device and contains blocks C, D, B. Backup record 310 is a backup record for a second device containing blocks E, F, B. Backup record 312 was a second backup record for the first device and contains blocks C, F, B.

The block allocation record 302 is arranged to track which backups use which blocks of data. Each line defines the beginning and end of a series of successive backup operations that use a specific block of data. For example, the first line of the block allocation record can be interpreted to mean that block A is used by the first backup operation. Similarly, the second line means that the first, second, third, and fourth backup operations have used block B. Block C is used in the first and second backups looking at the third line, and also used in the fourth backup in the seventh line.

The block allocation record 302 may be used for various operations that may be performed on the backup data as a whole. For example, the block allocation record 302 may be used during a purge operation to determine if a block of data is used for multiple backup operations and would be retained when removing blocks of data for a specific backup.

The backup database structure of embodiment 300 is designed to store blocks of data in a random sequence but use backup records 306, 308, 310, and 312 to place the blocks of data in the proper order to reconstruct a data storage device attached to a device. The backup records may be from different devices or from different backup sessions from a device.

Records 308 and 312 illustrate two backup sessions from a first device. In the first backup of record 308, the backup contained blocks C, D, B. In the second backup of record 312, the first device had blocks C, G, B. In the second device, block D was replaced by block G. From the block allocation record 302, block G is used in backup record 4, which corresponds to record 312. Thus, block G may have been copied from the remote device to the backup server and stored within the blocks of data 304.

The structure of embodiment 300 enables individual blocks of data to be used in multiple backup sessions and in different order or placement within the backup session. For example, from the second line of the block allocation record 302, block B is used in each of the four backup sessions. In backup record 306, block B is the second block in the backup sequence, while in the remaining backup records, block B is the third block in the backup sequence.

In some embodiments, a backup operation may be performed on a backup server to initially populate the block allocation record 302. An example of such an operation may be backup record 306. By performing a backup operation on its own data, a backup system may create and populate the data structure so that subsequent backup operations may reference the blocks of data that may exist from a set of potential backup data stored on the backup server. After one or more backup operations have been performed for other devices, or when additional storage space is needed on the backup server, some or all of the unused blocks of potential backup data may be erased from the backup storage. In the embodiment 300, block A is an example of a block of data that was used in the initial backup of the backup device 306, but not used in subsequent backups.

The hash table 314 may contain a listing of hash values with a corresponding pointer to specific blocks within the blocks of data 304. The hash table 314 may be sorted or organized to facilitate rapid lookup of hash values to compare to a hash value for a block to be backed up from a remote device. When the hash values are equal, a block of data on the backup server may be substituted for the block of data from the remote device and thus not be copied to the backup server.

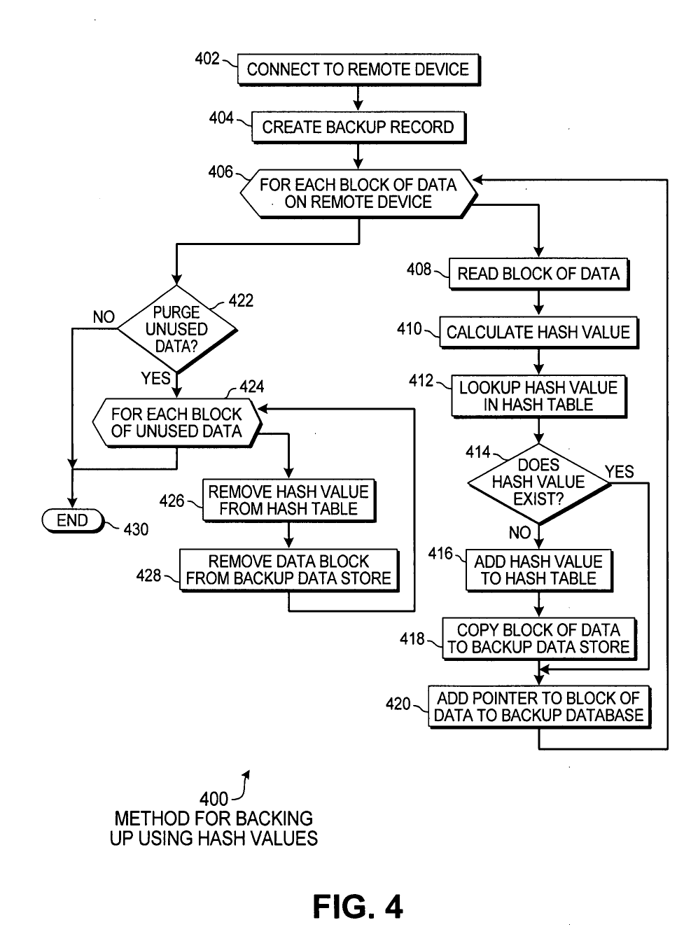

FIG. 4 is a flowchart illustration of an embodiment 400 showing a method for backing up using hash values. Embodiment 400 is one example of how hash values may be used to determine if a block of data from a remote device or other backup source is to be copied to a backup storage system. Embodiment 400 may be used with a backup data structure such as Embodiment 300.

Embodiment 400 is an example of a backup operation performed by a backup server for a remote device. Other embodiments may include those where a remote device performs a similar operation to backup data from the remote device to a backup server or storage device.

A connection is made between a backup server and a remote device in block 402. A backup record for the operation is created in block 404.

For each block of data on the remote device in block 406, the block of data is read in block 408 and a hash value calculated in block 410. The hash value of block 410 may be any technique that analyzes a block of data to determine a specific value or characteristic that may be used to uniquely identify the block of data.

The calculated hash value is looked up in the hash table of block 412. The hash table may contain hash values for each block of data already stored on a backup system. If the hash value does not exist in block 414, the hash value is added to the hash table in block 416 and the block of data is copied to the backup data store in block 418. If the hash value does exist in block 414, the process of copying in block 418 is skipped and a pointer to the block of data is added to the backup database. The process returns to block 406.

The mechanism of calculating a hash value and comparing the hash value to a table of hash values may be used to avoid copying data that already exists onto a backup storage system. In many cases, much of the data from one backup session to another is identical with minor changes to the data that are used during the period of time between backup sessions. By copying the changed data and creating a backup record that defines the sequence of blocks of data for the session, an entire backup session may be created with a minimum of data movement.

If data is to be purged in block 422, for each block of unused data in block 424, the hash value is removed from the hash table in block 426 and the corresponding data block may be removed from the data store in block 428. Otherwise, the process ends in block 420.

The purge operation of block 422 may be performed using different criteria. In some embodiments, a user action may initiate the purge operation. In other situations, the purge operation may be performed when a set number of backup sessions exists on a backup server or when the backup data storage system has reached a certain capacity.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
performing a backup of a first remote device to a backup system, said backup system comprising a set of potential backup data, said backup comprising:
connecting to said remote device;
determining that a first block of data from said remote device is equal to a second block of data from said set of potential backup data; and
storing a pointer to said second block of data in a first backup database.

2. The method of claim 1, said determining that a first block of data from said remote device is equal to a second block of data comprising calculating a first hash value for said first block of data and calculating a second hash value for said second block of data.

3. The method of claim 1 further comprising disabling at least a portion of said potential backup data.

4. The method of claim 3, said disabling comprising at least one of a group composed of operating a digital rights management system and removing at least one block of said potential backup data.

5. The method of claim 1, said backup system being one of a group composed of an incremental backup system, a block-based backup system.

6. The method of claim 1 further comprising:
performing a second backup of a second remote device to said backup system, said second backup comprising:
determining that a third block of data from said second remote device is equal to said second block of data from said set of potential backup data; and
storing a second pointer to said second block of data.

7. The method of claim 6, said second pointer being stored in said first backup database.

8. The method of claim 6, said second pointer being stored in a second backup database.

9. A computer readable medium comprising computer executable instructions adapted to perform the method of claim 1.

10. A method comprising:
determining a set of potential backup data;
loading at least a portion of said set of potential backup data on a backup system;
installing a backup application on said backup system, said backup application adapted to perform a backup of a first remote device, said backup comprising:
determining that a first block of data from said remote device is equal to a second block of data from said set of potential backup data; and
storing a pointer to said second block of data in a first backup database.

11. The method of claim 10 further comprising:
receiving a list of potential applications to be comprised in said set of potential backup data.

12. The method of claim 10 further comprising:
disabling at least a portion of said set of potential backup data on a backup system.

13. The method of claim 12, said disabling comprising operating a digital rights management system.

14. The method of claim 12, said disabling comprising removing a portion of said set of potential backup data.

15. The method of claim 10, said backup further comprising:
determining that a third block of data from a second remote device is equal to said second block of data from said set of potential backup data; and
storing a pointer to said second block of data in said first backup database.

16. A system comprising:
a network connection;
a data storage device;
a set of potential backup data stored on said data storage device; and
a backup system adapted to:
connect to a remote device;
determining that a first block of data from said remote device is equal to a second block of data from said set of potential backup data; and
storing a pointer to said second block of data in a first backup database.

17. The system of claim 16 further comprising:
a digital rights management system adapted to prevent said potential backup data from being used without authorization.

18. The system of claim 16, said backup system further adapted to:
connect to a second remote device;
determining that a third block of data from said second remote device is equal to a second block of data from said set of potential backup data; and
storing a second pointer to said second block of data.

19. The system of claim 18, said second pointer being stored in said first backup database.

20. The system of claim 16 further comprising:
a purge system adapted to:
define a first set of used blocks from said potential backup data and a second set of unused blocks from said potential backup data; and
remove at least a portion of said second set from said data storage device.
